(19) United States
(12) Patent Application Publication
(10) Pub. No.: US 2008/0115072 A1
(43) Pub. Date: May 15, 2008

(54) METHOD AND APPARATUS FOR VISUALLY ASSISTING LANGUAGE INPUT MODE INDENTIFICATION

(75) Inventor: Fang Lu, Billerica, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/558,121

(22) Filed: Nov. 9, 2006

(51) Int. Cl. G06F 3/048

(52) U.S. Cl. 715/765

(57) ABSTRACT

A method and apparatus for visually assisting language input mode identification is provided. The method includes selecting a plurality of language modes and a plurality of language icons. The method associates each of the plurality of language modes with one of the plurality of language icons and selects at least one application border and associates each of the plurality of language modes with one of application borders. An embodiment is directed towards a computer program for executing a language identification mode of an application. The program includes selecting at least one language mode selecting at least one language icon to form a plurality of language mode/language icon pairs. The program includes associating each of the language mode/language icon pairs with at least one keyboard key and selecting one of the pluralities of language mode/language icon pairs with an associated keyboard key.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to language editors and particularly to visually assisting language input mode identification within a multiple language editor.

2. Description of the Related Art

An input method editor (IME) is a program or operating system component that allows computer users to enter complex characters and symbols (such as Chinese, Japanese, Korean, and Tibetan characters), using a standard Western keyboard. It is also often called input method environment.

When a user switches between different language typing modes in current commercial Input Method Editor (IME) software and text editors, the user has to use the mouse (for example, to switch from English to French to Chinese). In some cases (Chinese for example), the IME lets the user use a “hot key” (in this example pressing the Shift key once), but the user can only switch back and forth between Chinese and English.

The problem is that it is not obvious while typing which input mode, i.e., which language, the user is currently using. The language bar is usually at the very bottom or top of the screen, which means that very often the user start may start typing thinking he or she is in one specific language while he or she is really using another language editor. Moreover, for most of the permutations, the user has to use the mouse to select a different keyboard configuration. This is a frustrating process for any user who needs to frequently switch languages while typing.

Even in the case when a “hot key” is provided, things can still be frustrating. For example, if one needs to type an upper case Latin character in the Chinese IME, he first needs to press the shift key, release it, and then press the shift key again and hold it down. If he depresses the shift key inadvertently, the user frequently ends up attempting to type its upper case letters while really generating Chinese symbols. Ensuring that the right character set is selected forces the user to look away from the writing area—at the bottom or the top of the screen. Again, this makes for a very inefficient typing process.

In addition, each time when the user needs to use a new input method, the user needs to add it to the language bar by going through a few steps in the Control Panel. For example, if the user types a text in English with French accents, along with some Chinese terms in it, the user needs to add Chinese and French to the language bar and then use the mouse to switch between the different modes.

U.S. Pat. No. 6,014,616: Discloses a method for monitoring the language used wherein the cursor in the character input area of the display device has a different color depending on the language being used by the operating system and enhances efficiency when alternately typing information in multiple languages. When the button is selected using a mouse or a shortcut key, the operating system switches the linguistic characters generated by signals from the keyboard to that of a different language. Discloses reading language data from the Input Method Editor for the current interface language and displays cursor having a color or shape that corresponds with the current language. This patent uses colors as the only visual cue to help user realize what is the current language mode he is in.

However, using color is not a very efficient indicator. Currently, there are 142 languages supported in Windows XP. That does not count the number of different locales for each language (Chinese from 5 different countries. English from 13 countries, Spanish from 19 countries), nor the fact that Asian languages can have many different IMEs. However, there are only 7 major colors within the available spectrum.

U.S. Pat. No. 6,388,686: Discloses a graphical user interface which allows the user to switch between display items among a group of display items and an indicator provides a visual cue to the user of which display item is currently selected for display. Discloses that character strings are entered into the baseString, sortString and altString fields by data input methods that may selectively utilize data from either the user's direct entry or specification, from transliteration engine, or from Input Method Editor (IME). Discloses changing the color of the background behind the text as a possible visual cue, but does not discuss associating different languages supported by the OS with current user's input mode.

U.S. Pat. No. 6,812,939: Discloses a method for signaling an event to a user of a computer system by displaying event object on the display screen with display attribute wherein the attribute might be color. This patent also uses colors as the visual cue to associate with the event type. Which, as pointed out earlier is ineffective and also requires the user to memorize which color is associated with which language.

Thus, there exists a need for a user friendly visual cue that lets user know which input mode, i.e., which language mode, is active—without their eyes leaving the text editing area. Preferably, the techniques provide for minimal user input and therefore rapid task completion.

### SUMMARY OF THE INVENTION

The shortcomings of the prior art are overcome and additional advantages are provided through the provision of a visual border and/or icon to identify the language mode of the application editor.

In accordance with one embodiment of the present invention a method for visually assisting language input mode identification is provided. The method includes selecting a plurality of language modes and selecting a plurality of language icons. The method further associates each of the plurality of language modes with one of the plurality of language icons. The method also selects at least one application border and associates each of the plurality of language modes with one of application borders.

An embodiment of the invention is also directed towards a computer program product stored on machine-readable media for executing machine-readable instructions for providing a language identification mode to an application. The instructions include selecting at least one language mode selecting at least one language icon to form a plurality of language mode/language icon pairs. The instructions also include associating each of the language mode/language icon pairs with at least one keyboard key and selecting one of the pluralities of language mode/language icon pairs with the associated keyboard key.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that tangibly embodies a program of instructions stored within a program storage device readable by a machine, and executable by the machine to perform a method for visually assisting language input mode identification. The method includes selecting a plurality of language modes and selecting a plurality of language icons from the group consisting of alphanumeric icons, national flag icons, and geographical icons. The method also includes selecting a plurality of application borders from the group consisting of color borders and symbol borders. The method further associates each of the plurality of language modes with one of the plurality of application borders and associates each of plurality of language mode/language icon pairs with at least one keyboard key; and selects one of the pluralities of language mode/language icon pairs with the associated keyboard key.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of an embodiment of a computing environment within which the present invention can operate;

FIG. 2 illustrates an exemplary user interface illustrating a unique border for indicating the input method editor's language mode;

FIG. 3 illustrates another exemplary user interface illustrating a unique border for indicating the input method editor's language mode;

FIG. 4 illustrates an exemplary user interface illustrating a unique icon for indicating the input method editor's language mode;

FIG. 5 illustrates another exemplary user interface illustrating a unique icon for indicating the input method editor's language mode; and

FIG. 6 illustrates one method of associating a unique border and a unique icon with a particular language in accordance with the teachings presented herein.

The detailed description explains the preferred embodiments of the invention, together with advantages and features, by way of example with reference to the drawings.

### DETAILED DESCRIPTION OF THE INVENTION

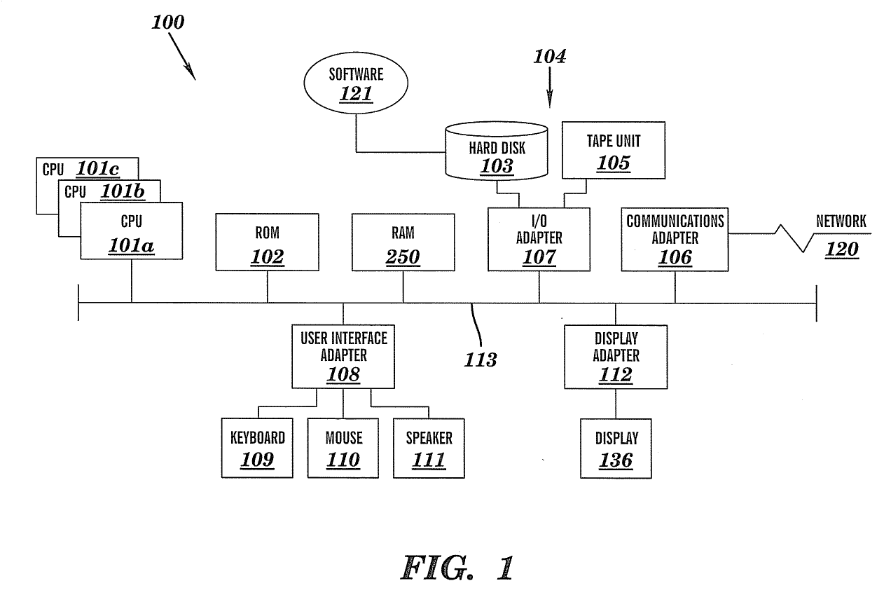

Referring now to FIG. 1, an embodiment of a processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an I/O adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media as software (for example, the hard disk 104) for providing visual cues that let a user know which input mode, i.e., which language mode, is active. The software 121 may be produced using software development tools as are known in the art.

As shown in FIG. 1, the system 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1.

It will be appreciated that the system 100 can be any suitable computer (e.g., 486, Pentium, Pentium II, Macintosh), Windows-based terminal, wireless device, information appliance, RISC Power PC, X-device, workstation, mini-computer, mainframe computer, cell phone, personal digital assistant (PDA) or other computing device.

Examples of operating systems supported by the system 100 include Windows 95, Windows 98, Windows NT 4.0, Windows XP, Windows 2000, Windows CE, Macintosh, Java, LINUX, and UNIX, or any other suitable operating system. The system 100 also includes a network interface 120 for communicating over a network (not shown) 8. The network can be a local-area network (LAN), a metro-area network (MAN), or wide-area network (WAN), such as the Internet or World Wide Web.

Users of the system 100 can connect to the network through any suitable connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

Embodiments of the present invention relate to a software application for providing a user-friendly visual cue that lets user know which input mode is active—without the user's eyes leaving the text editing area. The functionality of the software application, or software 121 can be incorporated into existing applications such as office applications, email applications, and input method editors.

The visual cue could be either a colored border surrounding the text editor, or application window, an icon next to the cursor in the text editor, or a colored icon. The color or cue is configurable by the user (for example, the blue color could mean the English-US input mode is on). Also, the user can define shortcut keys to switch between different modes, i.e., different languages, at will, without the need to use the mouse (and thus take one hand off the keyboard). For example, Ctrl+E for English, Ctrl+F for French, and Ctrl+C for Chinese.

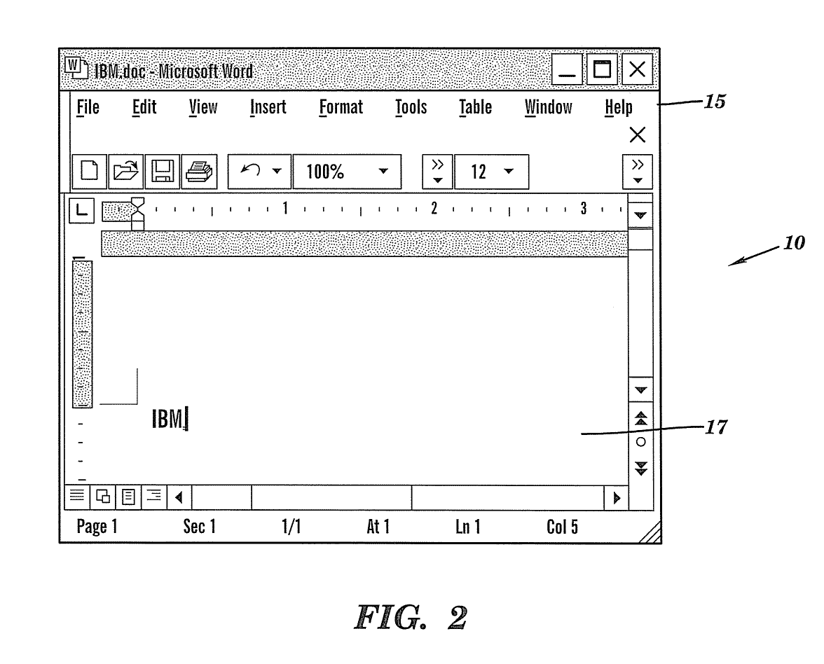

Referring to FIG. 2 there is shown an embodiment of the invention using a colored border 15 surrounding the text editor 10. While the user types in English mode in the text area 17, a red border 15 surrounds the text editor 10. It will be appreciated that the border 15 may be any suitable border indicating the current language mode of the input method editor. For example, the border 15 can be a user selected color or a predetermined default color. It will be further appreciated that the border 15 can also contain any suitable symbols indicating the current language mode of the input method editor. For example, the border 15 can contain multiple user-selected letters repeated within the border 15, e.g., “E” for English (not shown for clarity).

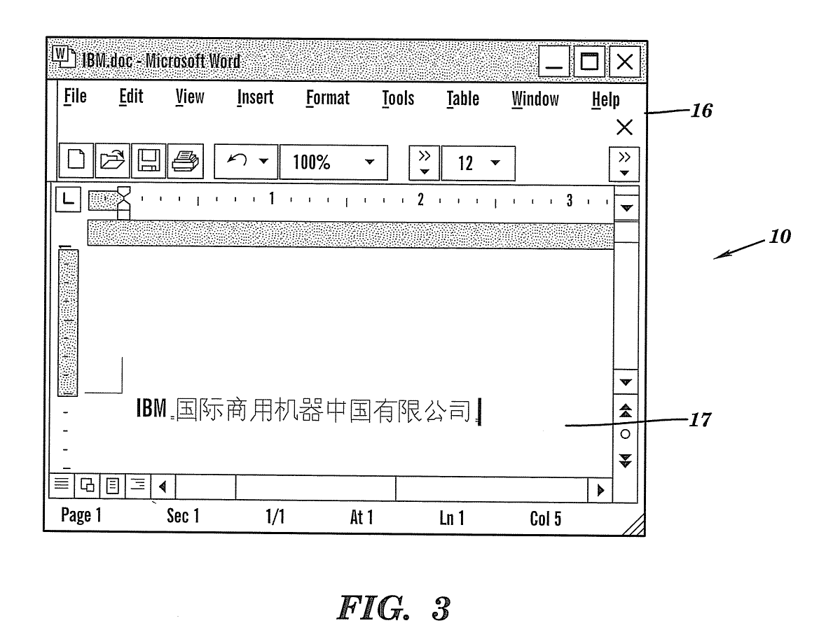

Referring also to FIG. 3 there is shown an embodiment of the invention using a colored border 16 surrounding the text editor 10. When the user switches to Chinese mode and is typing in the text area 17, a blue border 16 surrounds the text editor 10. It will be appreciated that the border may be any suitable border indicating the current language mode of the input method editor. For example, the border can be a user selected color or a predetermined default color. It will be further appreciated that the border can also contain any suitable symbols indicating the current language mode of the input method editor. For example, the border 16 can contain multiple user-selected letters repeated within the border 16, e.g., “C” for Chinese.

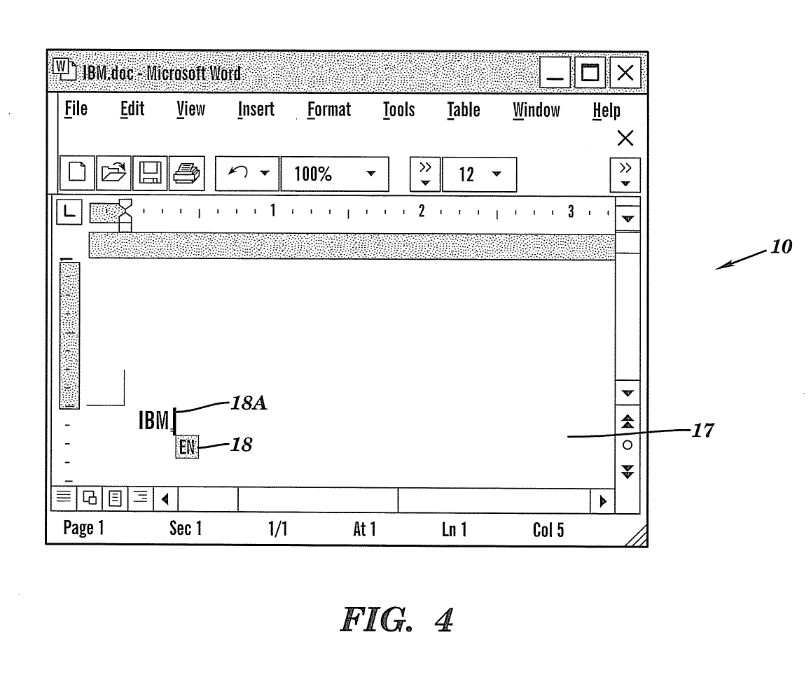

Referring to FIG. 4 there is shown an embodiment of the invention using an icon next to the cursor to indicate which typing or language mode the user is in when using the text editor 10. While the user types in English mode in the text area 17, the icon next to the cursor 18A shows “EN” for English to indicated the editor's current language mode. It will be appreciated that the icon 18 be any suitable icon indicating the current language mode of the input method editor. For example, the icon 18 can be a user selected icon or a predetermined icon. For example, the icon 18 can be a national flag representing the language's country of origin. Another example is the icon 18 can be a map or other geographical representation of the language's country of origin. It will be further appreciated that the icon 18 can also contain any suitable symbols indicating the current language mode of the input method editor. For example, the icon 18 can contain multiple user-selected letters within the icon 18, e.g., “E” for English (not shown for clarity).

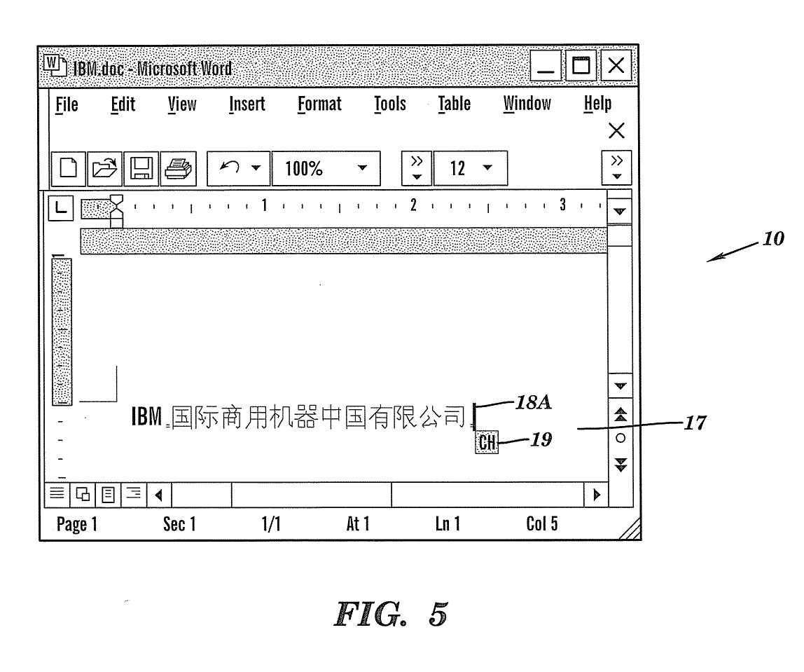

Referring also to FIG. 5 there is shown an embodiment of the invention using an icon next to the cursor to indicate which typing or language mode the user is in when using the text editor 10. While the user types in Chinese mode in the text area 17, the icon next to the cursor 18A shows “CH” for Chinese to indicated the editor's current language mode.

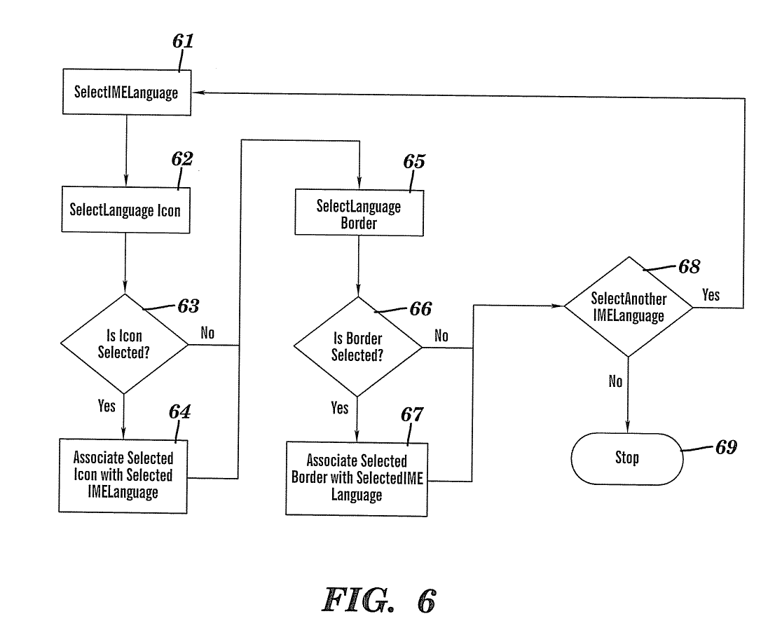

Referring to FIG. 6 there is shown one method of associating a unique border and a unique icon with a particular language in accordance with the teachings presented herein. Referring also to FIG. 1, a user selects 61 an IME language via keyboard 109 or mouse 110. Also via keyboard 109 or mouse 110, user selects 62 a language icon to be associated with the selected language. If an icon is selected 63 the icon (see FIG. 4, item 18) is associated 64 with the selected language.

Still referring to FIG. 6 and FIG. 1, a user selects 65 an IME border. If a border is selected 66, the border (see FIG. 2, item 15) is associated 67 with the selected language. If there is another IME language 68 the process repeats, else the process stops 69.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While multiple embodiments to the invention have been described, it will be understood that those skilled in the art, both now and in the future, may make various improvements and enhancements which fall within the scope of the claims which follow. For example, it will be understood that the user can define shortcut keys via keyboard 109, FIG. 1, to switch cross different modes. For example, Ctrl+E for English, Ctrl+F for French, and Ctrl+C for Chinese. It will also be understood that the color border embodiment of the present invention and the icon embodiment of the present invention may be operated concurrently. In one embodiment the user may also have the option to turn off the icon once the user is familiar enough to remember the color or symbol border's language reference. These claims should be construed to maintain the proper protection for the invention described herein.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

What is claimed is:

1. A method for visually assisting language input mode identification, the method comprising:
selecting a plurality of language modes;
selecting a plurality of language icons; and
associating each of the plurality of language modes with one of the plurality of language icons.

2. The method as in claim 1 wherein selecting the plurality of language icons comprises selecting a plurality of alpha-numeric icons.

3. The method as in claim 1 wherein selecting the plurality of language icons comprises selecting a plurality of national flag icons.

4. The method as in claim 1 wherein selecting the plurality of language icons comprises selecting a plurality of geographical icons.

5. The method as in claim 1 further comprising:
selecting a plurality of application borders; and
associating each of the plurality of language modes with one of the plurality of application borders.

6. The method as in claim 5 wherein selecting the plurality of application borders comprises selecting a plurality of color application borders.

7. The method as in claim 5 wherein selecting plurality of application borders comprises selecting a plurality of symbol application borders.

8. A computer program product stored on machine readable media for executing machine readable instructions for providing a language identification mode to an application, the instructions for:
selecting a plurality of language modes;
selecting a plurality of language icons;
associating each of the plurality of language modes with one of the plurality of language icons to form a plurality of language mode/language icon pairs;
associating each of plurality of language mode/language icon pairs with at least one keyboard key; and
selecting one of the plurality of language mode/language icon pairs with the associated at least one keyboard key.

9. The computer program product as in claim 8 wherein selecting the plurality of language icons comprises selecting a plurality of alpha-numeric icons.

10. The computer program product as in claim 8 wherein selecting the plurality of language icons comprises selecting a plurality of national flag icons.

11. The computer program product as in claim 8 wherein selecting the plurality of language icons comprises selecting a plurality of geographical icons.

12. The computer program product as in claim 8 further comprising instructions for:
selecting a plurality of application borders; and
associating each of the plurality of language modes with one of the plurality of application borders.

13. The computer program product as in claim 8 further comprising instructions for: selecting a plurality of color application borders.

14. The computer program product as in claim 8 further comprising instructions for: selecting a plurality of symbol application borders.

15. A program storage device readable by a machine, tangibly embodying a program of instructions executable by the machine to perform a method for visually assisting language input mode identification, the method comprising:
selecting a plurality of language modes;
selecting a plurality of language icons, wherein selecting the plurality of language icons further comprises:
selecting the plurality of language icons from the group consisting of alpha-numelic icons, national flag icons, and geographical icons;
associating each of the plurality of language modes with one of the plurality of language icons to form a plurality of language mode/language icon pairs;
selecting a plurality of application borders wherein selecting the plurality of application borders comprises:
selecting the plurality of application borders from the group consisting of color borders and symbol borders;
associating each of the plurality of language modes with one of the plurality of application borders;
associating each of plurality of language mode/language icon pairs with at least one keyboard key; and
selecting one of the plurality of language mode/language icon pairs with the associated at least one keyboard key.
